(19) United States
(12) Patent Application Publication
(10) Pub. No.: US 2011/0054917 A1
(43) Pub. Date: Mar. 3, 2011

(54) APPARATUS AND METHOD FOR STRUCTURING BITSTREAM FOR OBJECT-BASED AUDIO SERVICE, AND APPARATUS FOR ENCODING THE BITSTREAM

(75) Inventors: Tae Jin LEE, Daejeon (KR); Min Je KIM, Daejeon (KR); Kyeongok KANG, Daejeon (KR); Dae Young JANG, Daejeon (KR); Inseon JANG, Daejeon (KR); Seung Kwon BEACK, Seoul (KR); Jin Woo HONG, Daejeon (KR)

(73) Assignee: Electronics and Telecommunications Research Institute, Daejeon (KR)

(21) Appl. No.: 12/871,134

(22) Filed: Aug. 30, 2010

(30) Foreign Application Priority Data
Aug. 28, 2009 (KR) 10-2009-0080683
Dec. 21, 2009 (KR) 10-2009-0127946

(51) Int. Cl. G10L 19/00

(52) U.S. Cl. 704/501; 704/500; 704/E19.001

(57) ABSTRACT

Provided are a method and apparatus for structuring a bitstream for an object-based audio service, and an apparatus for encoding the bitstream. A method of structuring a bitstream, may include: configuring the bitstream by separating the bitstream into a file header and frames of audio objects that are separated using a sound source separation scheme; and storing, in the file header, reproduction level information of audio objects.

### CROSS-REFERENCE TO RELATED APPLICATIONS

This application claims the benefit of Korean Patent Application No. 10-2009-0080683, filed on Aug. 28, 2009, and Korean Patent Application No. 10-2009-0127946, filed on Dec. 21, 2009, in the Korean Intellectual Property Office, the disclosures of which are incorporated herein by reference.

### BACKGROUND

1. Field of the Invention

The present invention relates to a method and apparatus for structuring a bitstream for an object-based audio service, and an apparatus for encoding the bitstream, and more particularly, to a method and apparatus for effectively providing an object-based audio service by including, in a bitstream, information associated with an upper bound value and a lower bound value when reproducing a sound source with a low quality.

2. Description of the Related Art

An audio signal provided using a broadcasting service such as TV broadcasting, radio broadcasting, Digital Multimedia Broadcasting (DMB), and the like may be mixed with other audio object obtained from various sound sources and thereby be stored and be transmitted as a single audio signal. In this environment, a user may adjust the volume of entire audio object and the like, whereas the user may not control a characteristic of an each sound object. For example, the user may not adjust volume of each sound source included in the transmitted single audio signal. In a content creation, when individually storing each sound object instead of mixing the audio object, the user may listen while controlling the volume of each sound object, and the like in a terminal. As described above, an audio service that enables the user to listen with appropriately controlling each audio object in a receiver, in such a manner that a storage end and a transmission end may individually store and transmit a plurality of audio object is referred to as an object-based audio service.

A sound source separation technology denotes a technology that may extract audio objects such as a vocal, a drum, and the like from a sound source, down mixed to stereo and the like, using various types signal processing schemes. Accordingly, in the case of using the sound source separation technology, even though a corresponding sound signal includes a plurality of audio object that are down mixed in existing various stereo types, it is possible to extract, from the corresponding sound source, various types of sound object such as vocal, drum, piano, and the like. Accordingly, it is possible to easily obtain a content for an object-based audio service. When providing an object-based audio service using a separated sound source, it is difficult to perfectly separate a corresponding sound source due to a characteristic of the sound source separation technology. Consequently, each separated sound object may have a relatively low quality compared to an original sound object and thus, there is a need to set a range of controlling a sound object.

Accordingly, there is a desire for an effective bitstream structuring apparatus and method that may designate a control range of each separated sound object when producing an object-based audio content based on a low quality sound source obtained according to a sound source separation technology and the like.

### SUMMARY

An aspect of the present invention provides a method and apparatus for structuring a bitstream that may reduce a degradation in the sound quality occurring due to an excessive volume control by designating an upper bound value and a lower bound value of a reproduction volume in an object-based audio service using a relatively low quality sound source, and an apparatus for encoding the bitstream.

Another aspect of the present invention also provides a method and apparatus for structuring a bitstream that may more effectively reproduce an object-based audio by including, in a bitstream, preset information of audio objects, and an apparatus for encoding the bitstream.

According to an aspect of the present invention, there is provided a method of structuring a bitstream, including: configuring the bitstream by separating the bitstream into a file header and frames of audio objects that are separated using a sound source separation scheme; and storing, in the file header, reproduction level information of audio objects.

The method may further include storing, in the file header, preset information of the audio objects.

The reproduction level information may include at least one of a number of the audio objects, maximum reproduction level information of each of the audio objects, and minimum reproduction level information of each of the audio objects.

The preset information may include at least one of a number of presets associated with audio objects, a location of each of the audio objects, and a sound volume.

According to another aspect of the present invention, there is provided an apparatus for structuring a bitstream, including: a bitstream separation unit to configure the bitstream by separating the bitstream into a file header and frames of audio objects; and a reproduction level information storage unit to store, in the file header, reproduction level information of audio objects.

According to still another aspect of the present invention, there is provided an apparatus for encoding a bitstream, including: a bitstream separation unit to configure the bitstream including a file header and frames of audio objects that are separated using a sound source separation scheme; and an encoding unit to encode the bitstream, wherein the bitstream separation unit stores, in the file header, reproduction level information of audio objects.

According to yet another aspect of the present invention, there is provided an apparatus for decoding a bitstream, including: a decoding unit to decode an encoded bitstream and to thereby extract a file header and frames of audio object that are separated using a sound source separation scheme; and a reproduction information extraction unit to extract, from the file header, reproduction level information of audio objects.

### EFFECT

According to embodiments of the present invention, there may be provided a method and apparatus for structuring a bitstream that may reduce a degradation in the sound quality occurring due to an excessive volume control by designating an upper bound value and a lower bound value of a reproduction volume in an object-based audio service using a relatively low quality sound source, and an apparatus for encoding the bitstream.

Also, according to embodiments of the present invention, there may be provided a method and apparatus for structuring a bitstream that may more effectively reproduce an object-based audio by including, in a bitstream, preset information of audio objects, and an apparatus for encoding the bitstream.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a flowchart illustrating a method of structuring a bitstream for an object-based audio service according to an embodiment of the present invention;

FIG. 2 is a diagram illustrating a structure of a bitstream of an object-based audio according to an embodiment of the present invention;

FIG. 3 is a diagram illustrating a format of a file header in the bitstream of FIG. 2;

FIG. 4 is a block diagram illustrating an apparatus for structuring a bitstream for an object-based audio service according to an embodiment of the present invention;

FIG. 5 is a block diagram illustrating an apparatus for encoding a bitstream for an object-based audio service according to an embodiment of the present invention; and

FIG. 6 is a block diagram illustrating an apparatus for decoding a bitstream for an object-based audio service according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

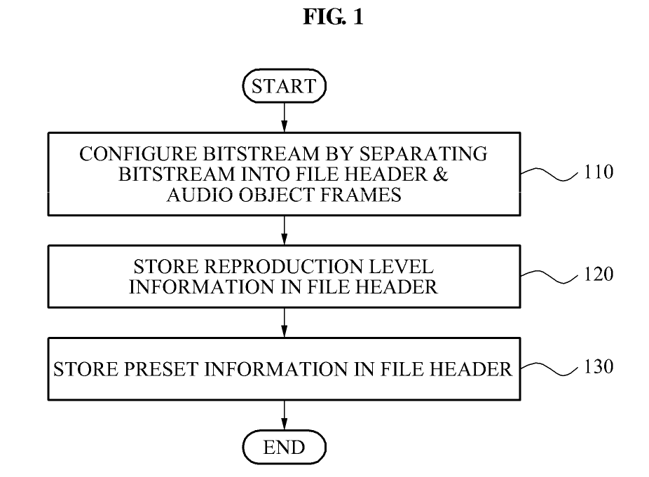

FIG. 1 is a flowchart illustrating a method of structuring a bitstream for an object-based audio service according to an embodiment of the present invention.

Referring to FIG. 1, in operation 110, a bitstream may be configured by separating the bitstream into a file header and frames of audio objects that are separated using a sound source separation scheme. Here, the file header may store information associated with each of audio objects, and each of the frames of audio objects may store frames of a substantially separated corresponding object.

In operation 120, reproduction level information of the audio objects may be stored in the file header. Here, the reproduction level information may include information associated with a maximum reproduction level and a minimum reproduction level. The maximum reproduction level may denote an upper bound value of volume controlling a corresponding audio object, and the minimum reproduction level may denote a lower bound value of the volume controlling the corresponding audio object.

The reproduction level information may include information associated with a number of audio objects and thus, it is possible to easily transfer information associated with the number of separated audio objects.

The reproduction level information may independently exist for each separated audio object. For example, when the number of separated audio objects is five, for example, vocal, drum, piano, base, and violin, maximum reproduction level information and minimum reproduction level information with respect to each of the five audio objects may be included in the file header.

In operation 130, preset information of the audio objects may be stored in the file header. The preset information may include at least one of a location of each of the audio objects and a sound volume.

Here, the preset information may include a number of presets associated with audio objects. For example, when five presets are to be transmitted, information indicating that the number of presets to be transmitted is five may be included in the preset information whereby the preset information may be transmitted.

As described above, since information associated with an upper bound value and a lower bound value is included in a bitstream and thereby is transmitted when reproducing a relatively low quality sound object obtained through a sound source separation technology and the like, it is possible to effectively provide an object-based audio service.

Hereinafter, a structure of the bitstream will be further described.

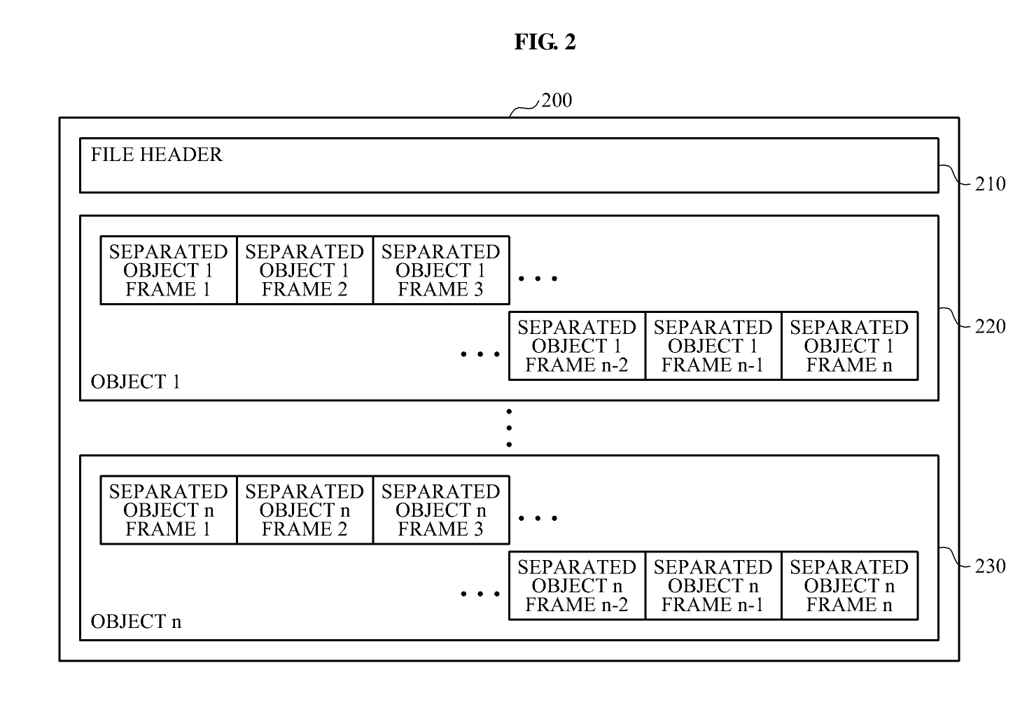

FIG. 2 is a diagram illustrating a structure of a bitstream 200 of an object-based audio according to an embodiment of the present invention.

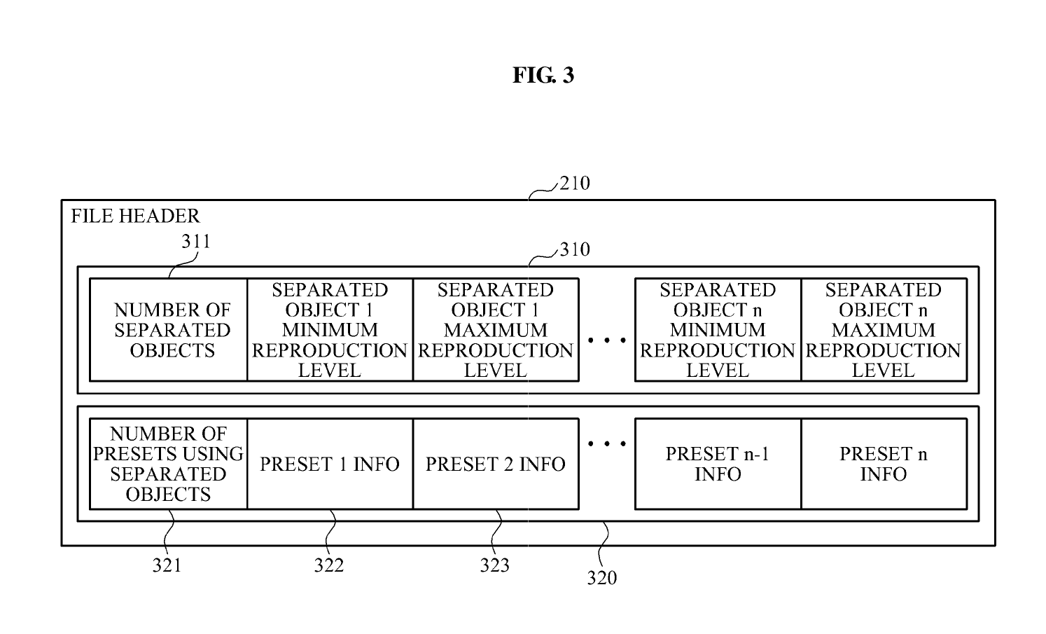

Referring to FIG. 2, the bitstream 200 of the object-based audio may include a file header 210 and a plurality of separated frames of audio objects 220 and 230. Here, a down-mixed sound source may be transmitted as a separated frames of audio objects for each separated sound source. The file header 210 will be further described with reference to FIG. 3.

FIG. 3 is a diagram illustrating a format of the file header 210 in the bitstream 200 of FIG. 2.

Referring to FIG. 3, the file header 210 may store reproduction level information 310 and preset information 320.

Due to characteristics of a sound source separation technology, it may be impossible to perfectly separate audio objects constituting a down-mixed audio signal. Therefore, when a user listens to the down-mixed audio signal by completely removing a particularly separated audio object, a quality of the sound source may be degraded by affecting the particularly separated audio object and other audio objects. When a minimum reproduction level is set with respect to each separated audio object, it may be possible to prevent the above degradation in the sound quality to some extents. When reproducing the separated audio object at least predetermined level value, the sound quality may be degraded due to distortion. Thus, there is a need to set a maximum reproduction level. In addition, due to the characteristics of the sound source separation technology, a maximum reproduction level and a minimum reproduction level may be different for each separated audio object and thus, there may be a need to set the maximum reproduction level and the minimum reproduction level for each separated audio object. Accordingly, the reproduction level information 310 may include information associated with the maximum reproduction level and the minimum reproduction level for each audio object.

The reproduction level information 310 may include information 311 associated with a number of separated audio objects. For example, when the down-mixed sound source is separated into five audio objects, “five” may be stored as the number of separated audio objects and thereby be transmitted. Accordingly, it is possible to easily transmit information regarding how many the separated audio objects are.

The preset information 320 may include a number of presets 321 using the audio objects, and preset information including preset 1 information 322 and preset 2 information 323. Specifically, the number of presets 321 and individual preset information, for example, the preset 1 information 322 and the preset 2 information 323 may be provided. The preset information may include a location of each audio object, a sound volume, and the like.

A bitstream configured according to an embodiment of the present invention may utilize, for an object-based audio service, a relatively low quality audio object that is obtained using a sound source separation technology. The bitstream may also utilize the relatively low quality audio object for an object-based audio service in a case where only a quality degraded sound source is available due to constraints on a sound source obtainment environment, and the like. In addition, the bitstream may be applicable to a method and apparatus for reducing the effect of a quality degradation against a user by limiting an object controlling range of the user.

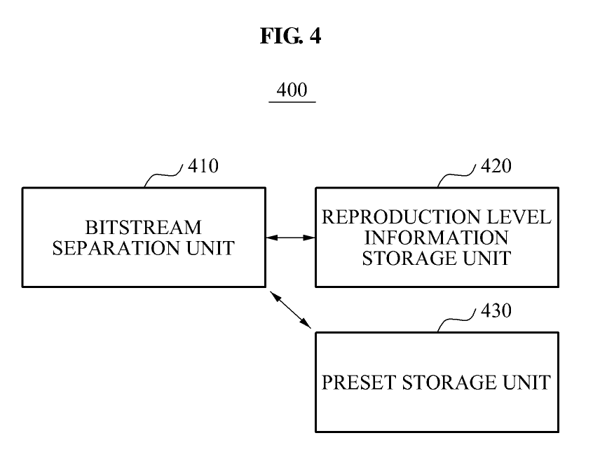

FIG. 4 is a block diagram illustrating an apparatus 400 for structuring a bitstream for an object-based audio service according to an embodiment of the present invention.

Referring to FIG. 4, the bitstream structuring apparatus 400 for the object-based audio service may include a bitstream separation unit 410 and a reproduction level information storage unit 420. The bitstream structuring apparatus 400 may further include a preset storage unit 430.

The bitstream separation unit 410 may configure a bitstream by separating the bitstream into a file header and frames of audio objects that are separated using a sound source separation scheme.

The reproduction level information storage unit 420 may store, in the file header, reproduction level information of audio objects. Here, the reproduction level information may include a number of the audio objects. The reproduction level information may include maximum reproduction level information of each of the audio objects and minimum reproduction level information of each of the audio objects. Specifically, it is possible to designate an upper bound value and a lower bound value of volume controllable by a user with respect to each audio object.

The preset storage unit 430 may store, in the file header, preset information of the audio objects. The preset information may include at least one of a number of presents, a location of each audio object, and a sound volume.

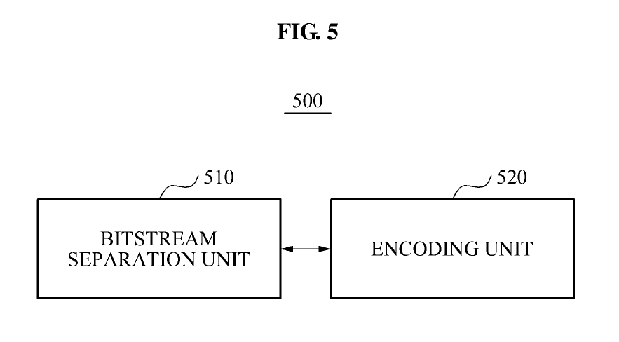

FIG. 5 is a block diagram illustrating an apparatus 500 for encoding a bitstream for an object-based audio service according to an embodiment of the present invention.

Referring to FIG. 5, the bitstream encoding apparatus 500 may include a bitstream separation unit 510 and an encoding unit 520.

The bitstream separation unit 510 may configure a bitstream including a file header and frames of audio objects that are separated using a sound source separation scheme. Here, the bitstream separation unit 510 may store, in the file header, reproduction level information and preset information in association with the audio objects.

The encoding unit 520 may encode the bitstream. Specifically, the encoding unit 520 may encode the bitstream in order to transmit the bitstream.

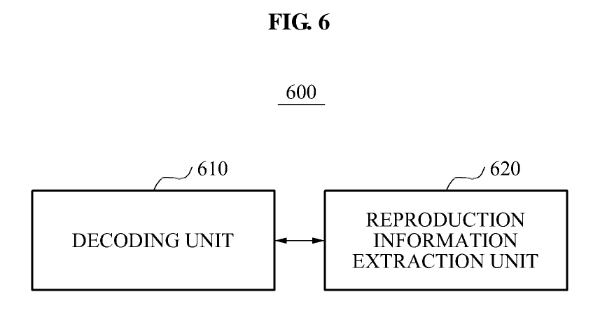

FIG. 6 is a block diagram illustrating an apparatus 600 for decoding a bitstream for an object-based audio service according to an embodiment of the present invention.

Referring to FIG. 6, the bitstream decoding apparatus 600 may include a decoding unit 610 and a reproduction information extraction unit 620.

The decoding unit 610 may decode an encoded bitstream to thereby extract a file header and frames of audio objects that are separated using a sound source separation scheme.

The reproduction information extraction unit 620 may extract, from the file header, reproduction level information of the audio objects. Here, the extracted reproduction level information may include maximum reproduction level information of each of audio objects and minimum reproduction level information of each of the audio objects. The file header may further include information associated with a number of audio objects that are separated from a sound source and thereby are transmitted, preset information of the audio objects, and the like. Accordingly, the reproduction information extraction unit 620 may further extract, from the file header, the transmitted information associated with the number of audio objects, the preset information, and the like. The preset information may include at least one of a number of presets associated with audio objects, a location of each audio object, and a sound volume.

Accordingly, the bitstream encoding apparatus 600 may reproduce a corresponding audio frame based on the extracted reproduction level information, preset information, and the like.

Descriptions not made above with reference to FIG. 4 through FIG. 6 may refer to descriptions made above with reference to FIG. 1 through FIG. 3.

As described above, according to embodiments of the present invention, it is possible to decrease a degradation in the sound quality occurring due to an excessive volume control by designating an upper bound value and a lower bound value of reproduction volume of each separated sound source in a bitstream for transmitting an object-based audio using a relatively low quality sound source.

Also, according to embodiments of the present invention, it is possible to more effectively reproduce an object-based audio by including preset information of audio objects in a bitstream.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of structuring a bitstream, comprising:
configuring the bitstream by separating the bitstream into a file header and frames of audio objects that are separated using a sound source separation scheme; and
storing, in the file header, reproduction level information of audio objects.

2. The method of claim 1, further comprising:
storing, in the file header, preset information of the audio objects.

3. The method of claim 1, wherein the reproduction level information comprises at least one of a number of the audio objects, maximum reproduction level information of each of the audio objects, and minimum reproduction level information of each of the audio objects.

4. The method of claim 2, wherein the preset information comprises at least one of a number of presets associated with audio objects, a location of each of the audio objects, and a sound volume.

5. An apparatus for structuring a bitstream, comprising:
a bitstream separation unit to configure the bitstream by separating the bitstream into a file header and frames of audio objects that are separated using a sound source separation scheme; and
a reproduction level information storage unit to store, in the file header, reproduction level information of audio objects.

6. The apparatus of claim 5, further comprising:
a preset storage unit to store, in the file header, preset information of the audio objects.

7. The apparatus of claim 5, wherein the reproduction level information comprises at least one of a number of the audio objects, maximum reproduction level information of each of the audio objects, and minimum reproduction level information of each of the audio objects.

8. The apparatus of claim 6, wherein the preset information comprises at least one of a number of presets associated with audio objects, a location of each of the audio objects, and a sound volume.

9. An apparatus for encoding a bitstream, comprising:
a bitstream separation unit to configure the bitstream including a file header and frames of audio objects that are separated using a sound source separation scheme; and
an encoding unit to encode the bitstream,
wherein the bitstream separation unit stores, in the file header, reproduction level information of audio objects.

10. The apparatus of claim 9, wherein the bitstream separation unit stores, in the file header, preset information of the audio objects.

11. The apparatus of claim 9, wherein the reproduction level information comprises at least one of a number of the audio objects, maximum reproduction level information of each of the audio objects, and minimum reproduction level information of each of the audio objects.

12. The apparatus of claim 10, wherein the preset information comprises at least one of a number of presets associated with audio objects, a location of each of the audio objects, and a sound volume.

13. An apparatus for decoding a bitstream, comprising:
a decoding unit to decode an encoded bitstream and to extract a file header and frames of audio objects that are separated using a sound source separation scheme; and
a reproduction information extraction unit to extract, from the file header, reproduction level information of audio objects.

14. The apparatus of claim 13, wherein the reproduction information extraction unit further extracts, from the file header, preset information of the audio objects.

15. The apparatus of claim 13, wherein the reproduction level information comprises at least one of a number of the audio objects, maximum reproduction level information of each of the audio objects, and minimum reproduction level information of each of the audio objects.

16. The apparatus of claim 14, wherein the preset information comprises at least one of a number of presets associated with audio objects, a location of each of the audio objects, and a sound volume.
